(19) United States
(12) Patent Application Publication
(10) Pub. No.: US 2023/0271610 A1
(43) Pub. Date: Aug. 31, 2023

(54) Vehicle Control System and Vehicle Control Method

(71) Applicants: Hyundai Motor Company, Seoul (KR); Kia Corporation, Seoul (KR)

(72) Inventors: Keun Jin Kim, Seongnam-si (KR); Sung Hyun CHO, Yongin-si (KR)

(21) Appl. No.: 17/933,151

(22) Filed: Sep. 19, 2022

(30) Foreign Application Priority Data
Feb. 25, 2022 (KR) 10-2022-0025430

(51) Int. Cl. B60W 30/14; B60W 30/18; B60W 40/04; B60W 40/105; B60W 50/00

(52) U.S. Cl. CPC B60W 30/143; B60W 30/181; B60W 30/18127; B60W 40/04; B60W 40/105; B60W 50/0097; B60W 2530/13; B60W 2555/60

(57) ABSTRACT

An embodiment vehicle includes a navigation device, a communication device, a processor, a non-transitory memory storing software that, when executed by the processor, causes the processor to set a reference traffic light and a front traffic light based on a current location, receive first operation information of the reference traffic light and second operation information of the front traffic light from a server, predict an operation of the front traffic light at a time point at which the vehicle is to pass through the front traffic light based on a vehicle speed, the first operation information, and the second operation information, and control driving according to the predicted operation.

### CROSS-REFERENCE TO RELATED APPLICATIONS

This application claims the benefit of Korean Patent Application No. 10-2022-0025430, filed on Feb. 25, 2022, which application is hereby incorporated herein by reference.

### TECHNICAL FIELD

The present disclosure relates to a vehicle control system and a vehicle control method.

### BACKGROUND

Recently, as the demand for electric vehicles increases, a technology for improving the limitations of existing electric vehicles is required, and in particular, a technology for improving an electric mileage of electric vehicles by efficiently using a battery when driving a vehicle is required.

When the vehicle performs V2I (Vehicle to Infra) communication, it is possible to receive information related to real-time traffic conditions, emergencies, traffic flows, etc., so it is expected to be able to efficiently improve fuel efficiency when using the received information.

### SUMMARY

Embodiments of the present disclosure can solve problems occurring in the prior art while advantages achieved by the prior art are maintained intact.

An embodiment of the present disclosure provides a vehicle control system and method capable of improving an electric mileage of a vehicle based on information received by a vehicle when the vehicle performs V2I communication.

The technical problems solvable by embodiments the present disclosure are not limited to the aforementioned problems, and any other technical problems not mentioned herein will be clearly understood from the following description by those skilled in the art to which the present disclosure pertains.

According to an embodiment of the present disclosure, a vehicle control system includes a server that collects information of traffic lights existing on a route to a destination, and a vehicle that sets a reference traffic light and a front traffic light based on a current location, receives first operation information of the reference traffic light and second operation information of the front traffic light from the server, predicts an operation of the front traffic light at a time point at which the vehicle is to pass through the front traffic light based on a vehicle speed, the first operation information, and the second operation information, and controls driving according to the predicted operation.

The first operation information and the second operation information may include lighting holding times and a lighting order of traffic lights including a green light and a red light.

The vehicle may calculate a first time point at which the vehicle is to pass through the front traffic light while driving at a road speed limit and predict an operation of the front traffic light at the first time point when the reference traffic light has a green lighting state.

The vehicle may control the vehicle to drive at the road speed limit until the vehicle has reached the front traffic light when it is predicted that the front traffic light has a green lighting state at the first time point.

The vehicle may calculate a vehicle speed for allowing a battery to be charged maximally by regenerative braking until the vehicle has reached the front traffic light and maximizing an electric mileage, and control the vehicle to drive to the front traffic light at the calculated vehicle speed and then stop when it is predicted that the front traffic light has the red lighting state at the first time point.

The vehicle may calculate a second time point at which the vehicle is to pass through the front traffic light when the vehicle accelerates to a road speed limit from a stopped state and drives and predict an operation of the front traffic light at the second time point when the reference traffic light has a red lighting state.

The vehicle may control the vehicle to drive at the road speed limit until the vehicle has reached the front traffic light when it is predicted that the front traffic light has a green lighting state at the second time point.

The vehicle may calculate a vehicle speed for allowing a battery to be charged maximally by regenerative braking until the vehicle has reached the front traffic light and maximizing an electric mileage, and control the vehicle to drive to the front traffic light at the calculated vehicle speed and then stop when it is predicted that the front traffic light has a red lighting state at the second time point.

The front traffic light may include a traffic light existing at a location closest to the reference traffic light in a driving direction of the vehicle.

According to an embodiment of the present disclosure, a vehicle control method includes setting a reference traffic light and a front traffic light based on a current location, receiving first operation information of the reference traffic light and second operation information of the front traffic light from a server that collects information of traffic lights existing on a route to a destination, predicting an operation of the front traffic light at a time point at which the vehicle is to pass through the front traffic light based on a vehicle speed, the first operation information, and the second operation information, and controlling driving of the vehicle according to the predicted operation of the front traffic light.

The first operation information and the second operation information may include lighting holding times and a lighting order of traffic lights including a green light and a red light.

The predicting of the operation of the front traffic light may include calculating a first time point at which the vehicle is to pass through the front traffic light while driving at a road speed limit when the reference traffic light has a green lighting state, and predicting an operation of the front traffic light at the first time point.

The controlling of the driving of the vehicle according to the predicted operation of the front traffic light may include controlling the vehicle to drive to the front traffic light at the road speed limit when it is predicted that the front traffic light has a green lighting state at the first time point.

The controlling of the driving of the vehicle according to the predicted operation of the front traffic light may include calculating a vehicle speed for allowing a battery to be charged maximally by regenerative braking until the vehicle has reached the front traffic light and maximizing an electric mileage, and controlling the vehicle to drive to the front traffic light at the calculated vehicle speed and then stop when it is predicted that the front traffic light has a red lighting state at the first time point.

The predicting of the operation of the front traffic light may include calculating a second time point at which the vehicle is to pass through the front traffic light when the vehicle accelerates to a road speed limit from a stopped state and drives when the reference traffic light has a red lighting state and predicting an operation of the front traffic light at the second time point.

The controlling of the driving of the vehicle according to the predicted operation of the front traffic light may include controlling the vehicle to drive to the front traffic light at the road speed limit when it is predicted that the front traffic light has a green lighting state at the second time point.

The controlling of the driving of the vehicle according to the predicted operation of the front traffic light may include calculating a vehicle speed for allowing a battery to be charged maximally by regenerative braking until the vehicle has reached the front traffic light and maximizing an electric mileage and controlling the vehicle to drive to the front traffic light at the calculated vehicle speed and then stop when it is predicted that the front traffic light has a red lighting state at the second time point.

The front traffic light may include a traffic light existing at a location closest to the reference traffic light in a driving direction of the vehicle.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a diagram illustrating a configuration of a vehicle control system according to an embodiment of the present disclosure;

FIG. 2 is a diagram illustrating a configuration of a vehicle control apparatus according to an embodiment of the present disclosure;

FIG. 3 is a diagram illustrating a configuration of a server according to an embodiment of the present disclosure;

FIG. 4 is a diagram illustrating a vehicle control method according to an embodiment of the present disclosure; and

FIG. 5 illustrates a configuration of a computing system for executing a method according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

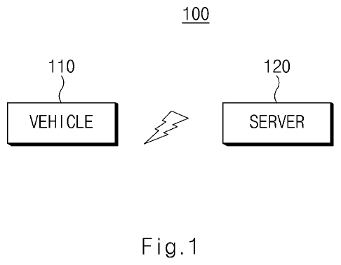

FIG. 1 is a diagram illustrating a configuration of a vehicle control system according to an embodiment of the present disclosure.

Referring to FIG. 1, a vehicle control system 100 of embodiments of the present disclosure may include a vehicle 110 and a server 120.

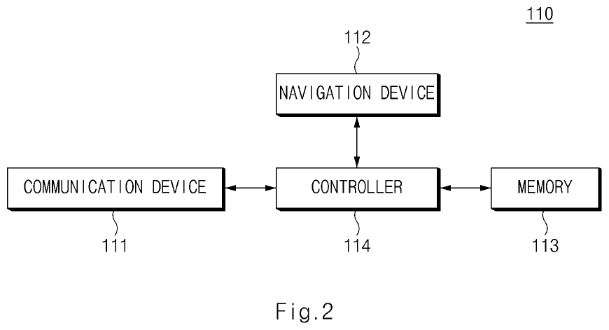

The vehicle 110 may set a traffic light at a current location as a reference traffic light, receive first operation information of the reference traffic light and second operation information of a front traffic light ahead of the reference traffic light from the server 120, predict an operation of the front traffic light at a time point at which the vehicle is to pass through the front traffic light based on a vehicle speed, the first operation information, and the second operation information and control driving of the vehicle according to the predicted operation. A more detailed description will be given with reference to FIG. 2.

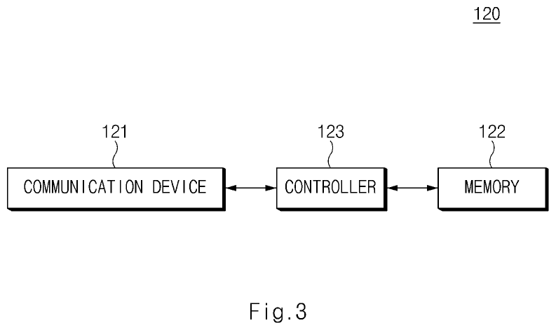

The server 120 may collect operation information of a traffic light existing on a route to a destination and transmit the operation information to the vehicle 110. A more detailed description will be given with reference to FIG. 3.

FIG. 2 is a diagram illustrating a configuration of a vehicle control apparatus according to an embodiment of the present disclosure.

Referring to FIG. 2, the vehicle 110 may include a communication device 11, a navigation device 112, a memory (i.e., storage) 113, and a controller 114.

The communication device in may perform wireless communication with the server 120. According to an embodiment, the communication device in may communicate with the server 120 in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), or Long Term Evolution (LTE).

In addition, the communication device in may perform vehicle to infrastructure (V2I) communication with the server 120 and perform V2I wireless communication with road infrastructure devices including traffic lights.

The navigation device 112 may include a GPS receiving device to receive a current location of the vehicle, and may provide a current vehicle speed and a route to a destination. The navigation device 112 may include a separate display device and a sound output device, and may provide the current location, the vehicle speed, and the route to a destination through the output device.

The memory 113 may store at least one or more algorithms for performing operations or execution of various commands for the operation of a vehicle according to an embodiment of the present disclosure. The memory 113 may include at least one medium of a flash memory, a hard disk, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disk, and an optical disk.

The controller 114 may be implemented by various processing devices such as a microprocessor incorporating a semiconductor chip capable of operating or executing various instructions or the like and may control an operation of the vehicle according to an embodiment of the present disclosure.

The controller 114 may set a traffic light at the current location as a reference traffic light. Here, the traffic light at the current location may include a traffic light at a location closest to the current location in the forward direction of the vehicle.

In addition, the controller 114 may set a front traffic light ahead of the reference traffic light. Here, the front traffic light may include a traffic light existing at a location closest to the reference traffic light in the driving direction of the vehicle.

The controller 114 may calculate a remaining distance from the current location to the front traffic light based on the location of the front traffic light from the server 120. In addition, the controller 114 may receive first operation information of the reference traffic light and second operation information of the front traffic light. Here, the first operation information and the second operation information may include the lighting holding times and lighting order of traffic lights including a green light and a red light.

The controller 114 may predict an operation of the front traffic light at the time point at which the vehicle is to pass through the front traffic light based on the remaining distance, the vehicle speed, the first operation information, and the second operation information, and control driving according to the predicted operation.

According to an embodiment, when the reference traffic light has a green lighting state, the controller 114 may set the vehicle speed to the road speed limit, calculate a first time point at which the vehicle is to pass through the front traffic light when the vehicle is driving the remaining distance, and predict the operation of the front traffic light at the first time point.

The controller 114 may predict a lighting state of the front traffic light at the first time point. When it is predicted that the front traffic light has the green lighting state at the first time point, the controller 114 may set the vehicle speed to the road speed limit and control the vehicle to drive to the front traffic light at the road speed limit.

On the other hand, when it is predicted that the front traffic light has the red lighting state at the first time point, the controller 114 may calculate a vehicle speed for allowing the battery to be charged maximally by regenerative braking until the vehicle has reached the front traffic light and maximizing an electric mileage, and control the vehicle to drive to the front traffic light at the calculated vehicle speed and then stop.

According to the embodiment, when the reference traffic light has a red lighting state, the controller 114 may calculate a second time point at which the vehicle is to pass through the front traffic light when the vehicle drives the remaining distance by accelerating to the road speed limit from a stopped state, and predict an operation of the front traffic light at the second time point.

The controller 114 may predict a lighting state of the front traffic light at the second time point. When it is predicted that the front traffic light has a green lighting state at the second time point, the controller 114 may set the vehicle speed to the road speed limit and control the vehicle to drive to the front traffic light at the road speed limit.

On the other hand, when it is predicted that the front traffic light has a red lighting state at the second time point, the controller 114 may calculate a vehicle speed for allowing the battery to be charged maximally by regenerative braking until the vehicle has reached the front traffic light and maximizing an electric mileage, and control the vehicle to drive to the front traffic light at the calculated vehicle speed and then stop.

When the vehicle is located at the front traffic light, the controller 114 may set a traffic light at the current location of the vehicle as a reference traffic light. That is, the controller 114 may set the front traffic light as the reference traffic light again, and set the front traffic light again in the above-described manner. The controller 114 may control the vehicle speed based on the traffic light information of traffic lights existing to a destination in the above-described manner and charge the battery to improve electric mileage thereby controlling the vehicle to drive while minimizing battery consumption.

FIG. 3 is a diagram illustrating a configuration of a server according to an embodiment of the present disclosure.

Referring to FIG. 3, the server 120 may include a communication device 121, a memory (i.e., storage) 122, and a controller 123.

The communication device 121 may perform wireless communication with the vehicle 110. According to an embodiment, the communication device 121 may communicate with the vehicle 110 in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), or Long Term Evolution (LTE).

In addition, the communication device 121 may perform vehicle to infrastructure (V2I) communication with the vehicle 110. Also, the communication device 121 may perform V2I wireless communication with road infrastructure devices including traffic lights.

The memory 122 may store at least one or more algorithms for performing operations or execution of various commands for the operation of a vehicle according to an embodiment of the present disclosure. The memory 122 may include at least one medium of a flash memory, a hard disk, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disk, and an optical disk.

The controller 123 may be implemented by various processing devices such as a microprocessor incorporating a semiconductor chip capable of operating or executing various instructions or the like and may control an operation of the server according to an embodiment of the present disclosure.

The controller 123 may receive route information from the vehicle 110 to a destination, and may collect information of traffic lights existing on the route to the destination. Here, the information may include location information and operation information, and the operation information may include the lighting holding times and lighting order of traffic lights including a green light and a red light. In addition, the controller 123 may transmit the collected information to the vehicle 110.

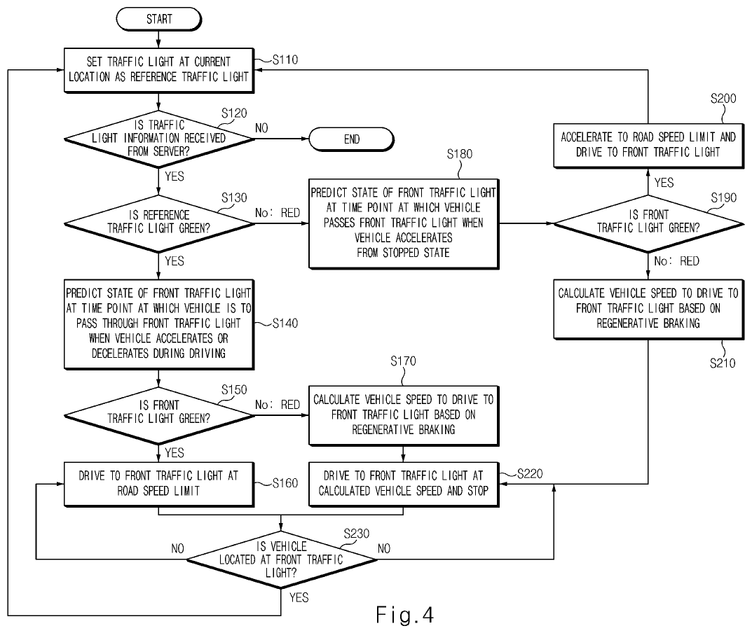

FIG. 4 is a diagram illustrating a vehicle control method according to an embodiment of the present disclosure.

Referring to FIG. 4, the vehicle 110 may set a traffic light at a current location to a reference traffic light (S110). Here, the traffic light at the current location may include a traffic light at a location closest to the current location in the forward direction of the vehicle. In addition, the vehicle 110 may set a front traffic light ahead of the reference traffic light. Here, the front traffic light may include a traffic light existing at a location closest to the reference traffic light in the driving direction of the vehicle.

The vehicle 110 may determine whether it is possible to receive traffic light information from the server 120 (S120). Here, the traffic light information may include location and operation information of the traffic lights. When the traffic light information cannot be received from the server 120 in S120, the operation is terminated.

When it is determined in S120 that the vehicle 110 is capable of receiving the traffic light information from the server 120 (Yes), the vehicle 110 may receive the location of the front traffic light, the first operation information of the reference traffic light, and the second operation information of the front traffic light. Here, the first operation information and the second operation information may include the lighting holding times and lighting order of traffic lights including a green light and a red light.

The vehicle 110 may determine whether the reference traffic light has a green lighting state (S130).

When it is determined in S130 that the reference traffic light has the green lighting state (Yes), the vehicle 110 may calculate a first time point at which the vehicle is to pass through the front traffic light and predict the operation of the front traffic light at the first time point (S140).

In S140, the vehicle 110 may calculate a remaining distance from the current location to the front traffic light based on the received location of the front traffic light, set the vehicle speed to a road speed limit, calculate a first time point at which the vehicle is to pass through the front traffic light during driving the remaining distance and predict a lighting state of the front traffic light at the first time point.

The vehicle 110 may determine whether the front traffic light has a green lighting state at the first time point (S150). In S150, when it is predicted that the front traffic light has the green lighting state at the first time point (Yes), the vehicle 110 may set the vehicle speed to the road speed limit and control the vehicle to drive to the front traffic light at the road speed limit (S160).

On the other hand, in S150, when it is predicted that the front traffic light is not in the green lighting state (the red lighting state) at the first time point (No), the vehicle 110 may calculate a vehicle speed for allowing the battery to be charged maximally by regenerative braking until the vehicle has reached the front traffic light and maximizing an electric mileage (S170). In addition, the vehicle 110 may be controlled to stop after driving at the calculated vehicle speed until the vehicle has reached the front traffic light (S220).

In S130, when the vehicle 110 determines that the reference traffic light is not in the green lighting state (the red lighting state) (No), the vehicle 110 may calculate a second time point at which the vehicle is to pass through the front traffic light, and predict the operation of the front traffic light at the second time point (S180).

In S180, the vehicle 110 may calculate a remaining distance from the current location to the front traffic light based on the received location of the front traffic light, set the vehicle speed to a road speed limit when the vehicle is stopping, calculate a second time point at which the vehicle is to pass through the front traffic light while the vehicle drives the remaining distance and predict a lighting state of the front traffic light at the second time point.

The vehicle 110 may determine whether the front traffic light has a green lighting state at the second time point (S190). In S190, when it is predicted that the front traffic light has the green lighting state at the second time point (Yes), the vehicle 110 may set the vehicle speed to the road speed limit and control the vehicle to drive to the front traffic light at the road speed limit (S200).

On the other hand, in S190, when it is predicted that the front traffic light is not in the green lighting state (the red lighting state) at the second time point (No), the vehicle 110 may calculate a vehicle speed for allowing the battery to be charged maximally by regenerative braking until the vehicle has reached the front traffic light and maximizing an electric mileage (S210). In addition, the vehicle 110 may be controlled to stop after driving at the calculated vehicle speed until the vehicle has reached the front traffic light (S220).

The vehicle 110 may determine whether the vehicle is located at the front traffic light (S230). When determining that the vehicle is located at the front traffic light in S230, the vehicle 110 may set a traffic light at a current location as a reference traffic light (S110). That is, the vehicle 110 may set the front traffic light as the reference traffic light again, and set the front traffic light again in the above-described manner. The controller 114 may control the vehicle speed based on the traffic light information of traffic lights existing to a destination in the above-described manner and charge the battery to improve electric mileage thereby controlling the vehicle to drive while minimizing battery consumption.

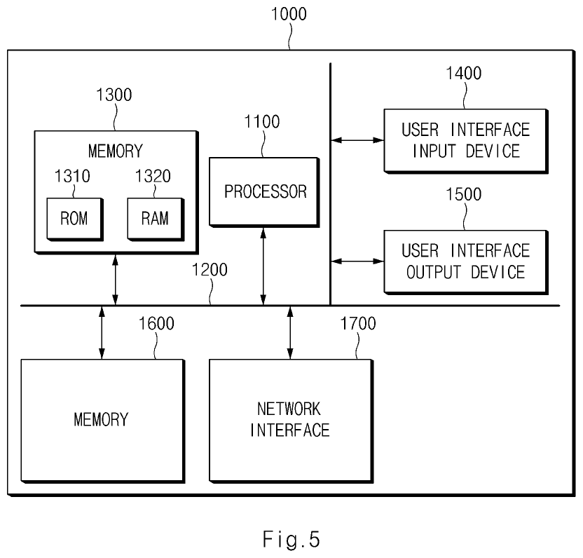

FIG. 5 illustrates a configuration of a computing system for executing a method according to an embodiment of the present disclosure.

Referring to FIG. 5, a computing system 1000 may include at least one processor 1100, a memory 1300, a user interface input device 1400, a user interface output device 1500, a memory (i.e., storage) 1600, and a network interface 1700, which are connected with each other via a bus 1200.

The processor 1100 may be a central processing unit (CPU) or a semiconductor device that processes instructions stored in the memory 1300 and/or the memory 1600. The memory 1300 and the memory 1600 may include various types of volatile or non-volatile storage media. For example, the memory 1300 may include a ROM (Read Only Memory) 1310 and a RAM (Random Access Memory) 1320.

Thus, the operations of the methods or the algorithms described in connection with the embodiments disclosed herein may be embodied directly in hardware or a software module executed by the processor 1100, or in a combination thereof. The software module may reside on a storage medium (that is, the memory 1300 and/or the memory 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the vehicle control system and method according to the embodiments of the present disclosure, it is possible to improve an electric mileage of a vehicle based on information received by a vehicle when the vehicle performs V2I communication and reduce battery consumption to increase a driving distance.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle comprising:
a navigation device;
a communication device;
a processor;
a non-transitory memory storing software that, when executed by the processor, causes the processor to:
set a reference traffic light and a front traffic light based on a current location;
receive first operation information of the reference traffic light and second operation information of the front traffic light from a server;
predict an operation of the front traffic light at a time point at which the vehicle is to pass through the front traffic light based on a vehicle speed, the first operation information, and the second operation information; and
control driving according to the predicted operation.

2. The vehicle of claim 1, wherein the first operation information and the second operation information comprise lighting holding times and a lighting order of traffic lights comprising a green light and a red light.

3. The vehicle of claim 1, wherein the software causes the processor to calculate a first time point at which the vehicle is to pass through the front traffic light while driving at a road speed limit and predict an operation of the front traffic light at the first time point when the reference traffic light has a green lighting state.

4. The vehicle of claim 3, wherein the software causes the processor to control the vehicle to drive at the road speed limit until the vehicle has reached the front traffic light when it is predicted that the front traffic light has the green lighting state at the first time point.

5. The vehicle of claim 3, wherein the software causes the processor to:
calculate a target vehicle speed for allowing a battery to be charged maximally by regenerative braking until the vehicle has reached the front traffic light and maximizing an electric mileage; and
control the vehicle to drive to the front traffic light at the calculated target vehicle speed and then stop when it is predicted that the front traffic light has a red lighting state at the first time point.

6. The vehicle of claim 1, wherein the software causes the processor to:
calculate a second time point at which the vehicle is to pass through the front traffic light when the vehicle accelerates to a road speed limit from a stopped state and drives at the road speed limit; and
predict an operation of the front traffic light at the second time point when the reference traffic light has a red lighting state.

7. The vehicle of claim 6, wherein the software causes the processor to control the vehicle to drive at the road speed limit until the vehicle has reached the front traffic light when it is predicted that the front traffic light has a green lighting state at the second time point.

8. The vehicle of claim 6, wherein the software causes the processor to:
calculate a target vehicle speed for allowing a battery to be charged maximally by regenerative braking until the vehicle has reached the front traffic light and maximizing an electric mileage; and
control the vehicle to drive to the front traffic light at the calculated target vehicle speed and then stop when it is predicted that the front traffic light has the red lighting state at the second time point.

9. The vehicle of claim 1, wherein the front traffic light comprises a traffic light existing at a location closest to the reference traffic light in a driving direction of the vehicle.

10. A method of controlling a vehicle, the method comprising:
setting a reference traffic light and a front traffic light based on a current location of a vehicle;
receiving first operation information of the reference traffic light and second operation information of the front traffic light from a server that collects information of traffic lights existing on a route to a destination;
predicting an operation of the front traffic light at a time point at which the vehicle is to pass through the front traffic light based on a vehicle speed, the first operation information, and the second operation information; and
controlling driving of the vehicle according to the predicted operation of the front traffic light.

11. The method of claim 10, wherein the first operation information and the second operation information comprise lighting holding times and a lighting order of traffic lights including a green light and a red light.

12. The method of claim 10, wherein predicting the operation of the front traffic light comprises:
calculating a first time point at which the vehicle is to pass through the front traffic light while driving at a road speed limit when the reference traffic light has a green lighting state; and
predicting an operation of the front traffic light at the first time point.

13. The method of claim 12, wherein controlling the driving of the vehicle according to the predicted operation of the front traffic light comprises controlling the vehicle to drive to the front traffic light at the road speed limit when it is predicted that the front traffic light has the green lighting state at the first time point.

14. The method of claim 12, wherein controlling the driving of the vehicle according to the predicted operation of the front traffic light comprises:
calculating a target vehicle speed for allowing a battery to be charged maximally by regenerative braking until the vehicle has reached the front traffic light and maximizing an electric mileage; and
controlling the vehicle to drive to the front traffic light at the calculated target vehicle speed and then stop when it is predicted that the front traffic light has a red lighting state at the first time point.

15. The method of claim 10, wherein predicting the operation of the front traffic light comprises:
calculating a second time point at which the vehicle is to pass through the front traffic light when the vehicle accelerates to a road speed limit from a stopped state and drives at the road speed limit when the reference traffic light has a red lighting state; and
predicting an operation of the front traffic light at the second time point.

16. The method of claim 15, wherein controlling the driving of the vehicle according to the predicted operation of the front traffic light comprises controlling the vehicle to drive to the front traffic light at the road speed limit when it is predicted that the front traffic light has a green lighting state at the second time point.

17. The method of claim 15, wherein controlling the driving of the vehicle according to the predicted operation of the front traffic light comprises:
calculating a target vehicle speed for allowing a battery to be charged maximally by regenerative braking until the vehicle has reached the front traffic light and maximizing an electric mileage; and
controlling the vehicle to drive to the front traffic light at the calculated target vehicle speed and then stop when it is predicted that the front traffic light has the red lighting state at the second time point.

18. The method of claim 10, wherein the front traffic light comprises a traffic light existing at a location closest to the reference traffic light in a driving direction of the vehicle.

19. A vehicle control system comprising:
a server configured to collect information of traffic lights existing on a route to a destination; and
a vehicle configured to:
set a reference traffic light and a front traffic light based on a current location;
receive first operation information of the reference traffic light and second operation information of the front traffic light from the server;
predict an operation of the front traffic light at a time point at which the vehicle is to pass through the front traffic light based on a vehicle speed, the first operation information, and the second operation information; and
control driving according to the predicted operation.
